(19) United States
(12) Patent Application Publication
(10) Pub. No.: US 2019/0065060 A1
(43) Pub. Date: Feb. 28, 2019

(54) CACHING INSTRUCTION BLOCK HEADER DATA IN BLOCK ARCHITECTURE PROCESSOR-BASED SYSTEMS

(71) Applicant: QUALCOMM Incorporated, San Diego, CA (US)

(72) Inventors: Anil Krishna, Lakeway, TX (US); Gregory Michael Wright, Chapel Hill, NC (US); Yongseok Yi, Cary, NC (US); Matthew Gilbert, Raleigh, NC (US); Vignyan Reddy Kothinti Naresh, Morrisville, NC (US)

(21) Appl. No.: 15/688,191

(22) Filed: Aug. 28, 2017

(51) Int. Cl. G06F 3/06; G06F 12/02; G06F 12/0802

(52) U.S. Cl. CPC G06F 3/064; G06F 12/0802; G06F 12/0246

(57) ABSTRACT

Caching instruction block header data in block architecture processor-based systems is disclosed. In one aspect, a computer processor device, based on a block architecture, provides an instruction block header cache dedicated to caching instruction block header data. Upon a subsequent fetch of an instruction block, cached instruction block header data may be retrieved from the instruction block header cache (if present) and used to optimize processing of the instruction block. In some aspects, the instruction block header data may include a microarchitectural block header (MBH) generated upon the first decoding of the instruction block by an MBH generation circuit. The MBH may contain static or dynamic information about the instructions within the instruction block. As non-limiting examples, the information may include data relating to register reads and writes, load and store operations, branch information, predicate information, special instructions, and/or serial execution preferences.

### BACKGROUND

### I. Field of the Disclosure

The technology of the disclosure relates generally to processor-based systems based on block architectures, and, in particular, to optimizing the processing of instruction blocks by block-based computer processor devices.

### II. Background

In conventional computer architectures, an instruction is the most basic unit of work, and encodes all the changes to the architectural state that result from its execution (e.g., each instruction describes the registers and/or memory regions that it modifies). Therefore, a valid architectural state is definable after execution of each instruction. In contrast, block architectures (such as the E2 architecture and the Cascade architecture, as non-limiting examples) enable instructions to be fetched and processed in groups called “instruction blocks,” which have no defined architectural state except at boundaries between instruction blocks. In block architectures, the architectural state needs to be defined and recoverable only at block boundaries. Thus, an instruction block, rather than an individual instruction, is the basic unit of work, as well as the basic unit for advancing an architectural state.

Block architectures conventionally employ an architecturally defined instruction block header, referred to herein as an “architectural block header” (ABH), to express meta-information about a given block of instructions. Each ABH is typically organized as a fixed-size preamble to each block of instructions in the instruction memory. At the very least, an ABH must be able to demarcate block boundaries, and thus the ABH exists outside of the regular set of instructions which perform data and control flow manipulation.

However, other information may be very useful for optimizing processing of an instruction block by a computer processing device. For example, data indicating a number of instructions in the instruction block, a number of bytes that make up the instruction block, a number of general purpose registers modified by the instructions in the instruction block, specific registers being modified by the instruction block, and/or a number of stores and register writes performed within the instruction block may assist the computer processing device in processing the instruction block more efficiently. While this additional data could be provided within each ABH, this would require a larger amount of storage space, which in turn would increase pressure on the computer processing device's instruction cache hierarchy that is responsible for caching ABHs. The additional data could also be determined on the fly by hardware when decoding an instruction block, but the decoding would have to be repeatedly performed each time the instruction block is fetched and decoded.

### SUMMARY OF THE DISCLOSURE

Aspects according to the disclosure include caching instruction block header data in block architecture processor-based systems. In this regard, in one aspect, a computer processor device, based on a block architecture, provides an instruction block header cache, which is a cache structure that is exclusively dedicated to caching instruction block header data. Upon a subsequent fetch of an instruction block, the cached instruction block header data may be retrieved from the instruction block header cache (if present) and used to optimize processing of the instruction block. In some aspects, the instruction block header data cached by the instruction block header cache may include “microarchitectural block headers” (MBHs), which are generated upon the first decoding of an instruction block and which contain additional metadata for the instruction block. Each MBH is dynamically constructed by an MBH generation circuit, and may contain static or dynamic information about the instruction block's instructions. As non-limiting examples, the information may include data relating to register reads and writes, load and store operations, branch information, predicate information, special instructions, and/or serial execution preferences. Some aspects may provide that the instruction block header data cached by the instruction block header cache may include conventional architectural block headers (ABHs) to alleviate pressure on the instruction cache hierarchy of the computer processor device.

In another aspect, a block-based computer processor device of a block architecture processor-based system is provided. The block-based computer processor device comprises an instruction block header cache comprising a plurality of instruction block header cache entries, each configured to store instruction block header data corresponding to an instruction block. The block-based computer processor device further comprises an instruction block header cache controller. The instruction block header cache controller is configured to determine whether an instruction block header cache entry of the plurality of instruction block header cache entries of the instruction block header cache corresponds to an instruction block identifier of an instruction block to be fetched next. The instruction block header cache controller is further configured to, responsive to determining that an instruction block header cache entry of the plurality of instruction block header cache entries of the instruction block header cache corresponds to the instruction block identifier, provide the instruction block header data of the instruction block header cache entry to an execution pipeline.

In another aspect, a method for caching instruction block header data of instruction blocks in a block-based computer processor device is provided. The method comprises determining, by an instruction block header cache controller, whether an instruction block header cache entry of a plurality of instruction block header cache entries of an instruction block header cache corresponds to an instruction block identifier of an instruction block to be fetched next. The method further comprises, responsive to determining that an instruction block header cache entry of the plurality of instruction block header cache entries of the instruction block header cache corresponds to the instruction block identifier, providing instruction block header data of the instruction block header cache entry of the plurality of instruction block header cache entries corresponding to the instruction block to an execution pipeline.

In another aspect, a block-based computer processor device of a block architecture processor-based system is provided. The block-based computer processor device comprises a means for determining whether an instruction block header cache entry of a plurality of instruction block header cache entries of an instruction block header cache corresponds to an instruction block identifier of an instruction block to be fetched next. The block-based computer processor device further comprises a means for providing instruction block header data of the instruction block header cache entry of the plurality of instruction block header cache entries corresponding to the instruction block to an execution pipeline, responsive to determining that an instruction block header cache entry of the plurality of instruction block header cache entries of the instruction block header cache corresponds to the instruction block identifier.

In another aspect, a non-transitory computer-readable medium having stored thereon computer-executable instructions is provided. The computer-executable instructions, when executed by a processor, cause the processor to determine whether an instruction block header cache entry of a plurality of instruction block header cache entries of an instruction block header cache corresponds to an instruction block identifier of an instruction block to be fetched next. The computer-executable instructions further cause the processor to, responsive to determining that an instruction block header cache entry of the plurality of instruction block header cache entries of the instruction block header cache corresponds to the instruction block identifier, provide instruction block header data of the instruction block header cache entry of the plurality of instruction block header cache entries corresponding to the instruction block to an execution pipeline.

### BRIEF DESCRIPTION OF THE FIGURES

FIG. 1 is a block diagram of an exemplary block architecture processor-based system including an instruction block header cache providing caching of instruction block headers, and an optional microarchitectural block header (MBH) generation circuit;

FIG. 2 is a block diagram illustrating the internal structure of an exemplary instruction block header cache of FIG. 1;

FIGS. 3A and 3B are a flowchart illustrating exemplary operations of the instruction block header cache of FIG. 1 for caching instruction block header data comprising an MBH generated by the MBH generation circuit of FIG. 1;

FIG. 4 is a flowchart illustrating additional exemplary operations of the instruction block header cache of FIG. 1 for caching instruction block header data comprising an architectural block header (ABH); and

FIG. 5 is a block diagram of an exemplary processor-based system that can include the instruction block header cache and the MBH generation circuit of FIG. 1.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

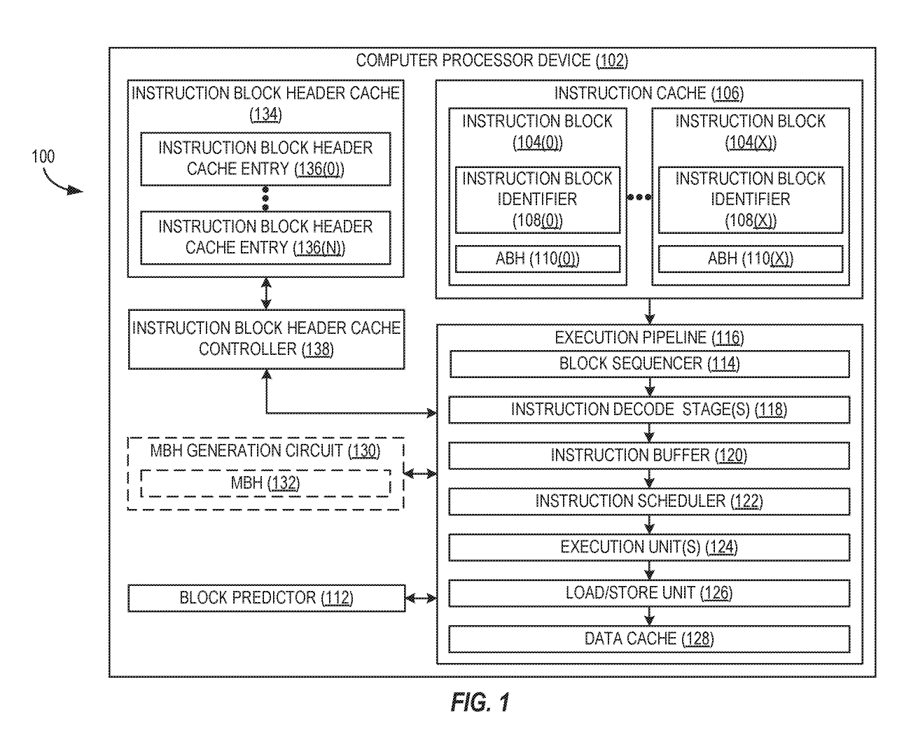

Aspects disclosed in the detailed description include caching instruction block header data in block architecture processor-based systems. In this regard, FIG. 1 illustrates an exemplary block architecture processor-based system 100 that includes a computer processor device 102. The computer processor device 102 implements a block architecture, and is configured to execute a sequence of instruction blocks, such as instruction blocks 104(0)-104(X). In some aspects, the computer processor device 102 may be one of multiple processor devices or cores, each executing separate sequences of instruction blocks 104(0)-104(X) and/or coordinating to execute a single sequence of instruction blocks 104(0)-104(X).

In exemplary operation, an instruction cache 106 (for example, a Level 1 (L1) instruction cache) of the computer processor device 102 receives instruction blocks (e.g., instruction blocks 104(0)-104(X)) for execution. It is to be understood that, at any given time, the computer processor device 102 may be processing more or fewer instruction blocks than the instruction blocks 104(0)-104(X) illustrated in FIG. 1. Each of the instruction block 104(0)-104(X) includes a corresponding instruction block identifier 108(0)-108(X), which provides a unique handle by which the instruction block 104(0)-104(X) may be referenced. In some aspects, the instruction block identifiers 108(0)-108(X) may comprise a physical or virtual memory address at which the corresponding instruction block 104(0)-104(X) begins. The instruction blocks 104(0)-104(X) also each include a corresponding architectural block header (ABH) 110(0)-110(X). Each ABH 110(0)-110(X) is a fixed-size preamble to the instruction block 104(0)-104(X), and provides static information that is generated by a compiler and that is associated with the instruction block 104(0)-104(X). At a minimum, each of the ABHs 110(0)-110(X) includes data demarcating the boundaries of the instruction block 104(0)-104(X) (e.g., a number of instructions within the instruction block 104(0)-104(X) and/or a number of bytes occupied by the instruction block 104(0)-104(X), as non-limiting examples).

A block predictor 112 determines a predicted execution path of the instruction blocks 104(0)-104(X). In some aspects, the block predictor 112 may predict an execution path in a manner analogous to a branch predictor of a conventional out-of-order processor (OoP). A block sequencer 114 within an execution pipeline 116 orders the instruction blocks 104(0)-104(X), and forwards the instruction blocks 104(0)-104(X) to one of one or more instruction decode stages 118 for decoding.

After decoding, the instruction blocks 104(0)-104(X) are held in an instruction buffer 120 pending execution. An instruction scheduler 122 distributes instructions of the active instruction blocks 104(0)-104(X) to one of one or more execution units 124 of the computer processor device 102. As non-limiting examples, the one or more execution units 124 may comprise an arithmetic logic unit (ALU) and/or a floating-point unit. The one or more execution units 124 may provide results of instruction execution to a load/store unit 126, which in turn may store the execution results in a data cache 128, such as a Level 1 (L1) data cache.

The computer processor device 102 may encompass any one of known digital logic elements, semiconductor circuits, processing cores, and/or memory structures, among other elements, or combinations thereof. Aspects described herein are not restricted to any particular arrangement of elements, and the disclosed techniques may be easily extended to various structures and layouts on semiconductor dies or packages. Additionally, it is to be understood that the computer processor device 102 may include additional elements not shown in FIG. 1, may include a different number of the elements shown in FIG. 1, and/or may omit elements shown in FIG. 1.

While data that is conventionally provided by the ABHs 110(0)-110(X) of the instruction blocks 104(0)-104(X) is useful in processing the instructions contained within the instruction blocks 104(0)-104(X), a greater variety of per-instruction-block metadata could allow the elements of the execution pipeline 116 to further optimize the fetching, decoding, scheduling, execution, and completion of the instruction blocks 104(0)-104(X). However, including such data as part of the ABHs 110(0)-110(X) would further increase the size of the ABHs 110(0)-110(X), and consequently would consume a larger amount of storage. Moreover, larger ABHs 110(0)-110(X) would reduce the capacity of the instruction cache 106, which may already be stressed by the generally lower density of instructions in block architectures.

Thus, to provide richer data regarding the properties of the instruction blocks 104(0)-104(X), the computer processor device 102 includes a microarchitectural block header (MBH) generation circuit (“MBH GENERATION CIRCUIT”) 130. The MBH generation circuit 130 receives data from the one or more instruction decode stages 118 of the execution pipeline 116 after decoding of an instruction block 104(0)-104(X), and generates an MBH 132 for the decoded instruction block 104(0)-104(X). The data included as part of the MBH 132 comprises static or dynamic information about the instructions within the instruction block 104(0)-104(X) that may be useful to the elements of the execution pipeline 116. Such data may include, as non-limiting examples, data relating to register reads and writes within the instruction block 104(0)-104(X), data relating to load and store operations within the instruction block 104(0)-104(X), data relating to branches within the instruction block 104(0)-104(X), data related to predicate information within the instruction block 104(0)-104(X), data related to special instructions within the instruction block 104(0)-104(X), and/or data related to serial execution preferences for the instruction block 104(0)-104(X).

The use of the MBH 132 may help to improve processing of the instruction blocks 104(0)-104(X), thereby improving the overall performance of the computer processor device 102. However, the MBH 132 for each one of the instruction blocks 104(0)-104(X) would have to be repeatedly generated each time the instruction block 104(0)-104(X) is decoded by the one or more instruction decode stages 118 of the execution pipeline 116. Moreover, a next instruction block 104(0)-104(X) could not be executed until the MBH 132 for the previous instruction block 104(0)-104(X) has been generated, which requires that all of the instructions of the previous instruction block 104(0)-104(X) have at least been decoded.

In this regard, the computer processor device 102 provides an instruction block header cache 134, which stores a plurality of instruction block header cache entries 136(0)-136(N), and an instruction block header cache controller 138. The instruction block header cache 134 is a cache structure dedicated to exclusively caching instruction block header data. In some aspects, the instruction block header data cached by the instruction block header cache 134 comprises MBHs 132 generated by the MBH generation circuit 130. Such aspects enable the computer processor device 102 to realize the performance benefits of the instruction block header data provided by the MBH 132 without the cost of relearning the instruction block header data every time the corresponding instruction block 104(0)-104(X) is fetched and decoded. Other aspects may provide that the instruction block header data comprises the ABHs 110(0)-110(X) of the instruction blocks 104(0)-104(X). Because aspects disclosed herein may store both the MBH 132 and/or the ABHs 110(0)-110(X), both may be referred to herein as “instruction block header data.”

In exemplary operation, the instruction block header cache 134 operates in a manner analogous to a conventional cache. The instruction block header cache controller 138 receives an instruction block identifier 108(0)-108(X) of a next instruction block 104(0)-104(X) to be fetched and executed. The instruction block header cache controller 138 then accesses the instruction block header cache 134 to determine whether the instruction block header cache 134 contains an instruction block header cache entry 136(0)-136(N) that corresponds to the instruction block identifier 108(0)-108(X). If so, a cache hit results, and the instruction block header data stored by the instruction block header cache entry 136(0)-136(N) is provided to the execution pipeline 116 to optimize processing of the corresponding instruction block 104(0)-104(X).

As noted above, some aspects of the instruction block header cache 134 store the MBH 132 as instruction block header data within the instruction block header cache entries 136(0)-136(N). In such aspects, after a cache hit occurs, the instruction block header cache controller 138 compares the MBH 132 generated by the MBH generation circuit 130 after decoding the corresponding instruction block 104(0)-104(X) with the instruction block header data provided from the instruction block header cache 134. If the MBH 132 previously generated does not match the instruction block header data, the instruction block header cache controller 138 updates the instruction block header cache 134 by storing the MBH 132 previously generated in the instruction block header cache entry 136(0)-136(N) corresponding to the instruction block 104(0)-104(X).

If no instruction block header cache entry 136(0)-136(N) corresponding to the instruction block identifier 108(0)-108(X) exists within the instruction block header cache 134 (i.e., a cache miss), the instruction block header cache controller 138 in some aspects stores instruction block header data for the associated instruction block 104(0)-104(X) as a new instruction block header cache entry 136(0)-136(N). In aspects in which the instruction block header data stored by the instruction block header cache entry 136(0)-136(N) comprises the MBH 132, the instruction block header cache controller 138 receives and stores the MBH 132 generated by the MBH generation circuit 130 as the instruction block header data after decoding of the corresponding instruction block 104(0)-104(X) is performed by the one or more instruction decode stages 118 of the execution pipeline 116. Aspects of the instruction block header cache 134 in which the instruction block header data comprises the ABH 110(0)-ABH 110(X) store the ABH 110(0)-ABH 110(X) of the corresponding instruction block 104(0)-104(X).

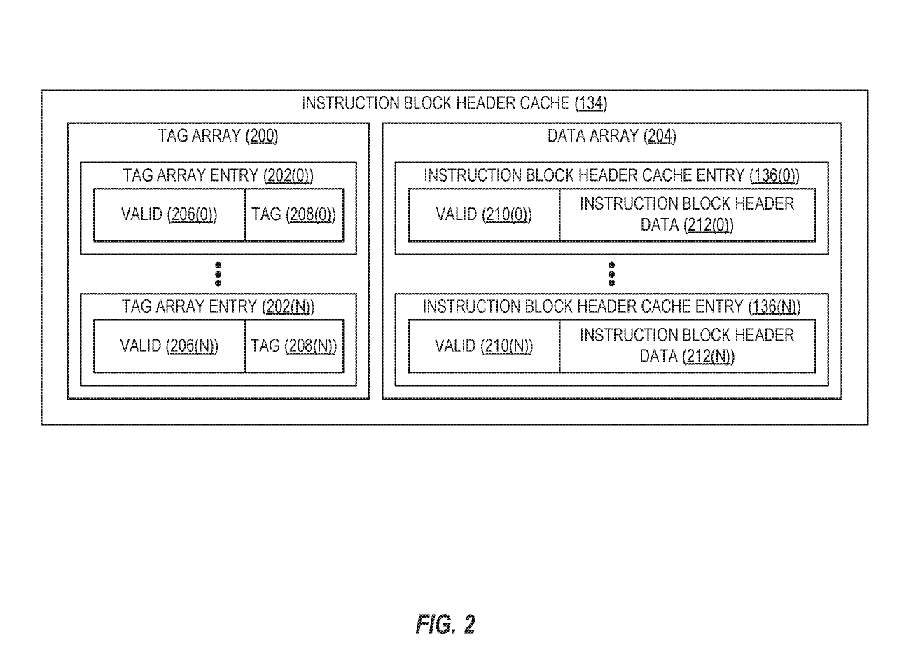

FIG. 2 provides a more detailed illustration of the contents of the instruction block header cache 134 of FIG. 1. As seen in the example of FIG. 2, the instruction block header cache 134 comprises a tag array 200 that stores a plurality of tag array entries 202(0)-202(N), and further comprises a data array 204 comprising the instruction block header cache entries 136(0)-136(N) of FIG. 1. Each of the tag array entries 202(0)-202(N) includes a valid indicator (“VALID”) 206(0)-206(N) representing a current validity of the tag array entry 202(0)-202(N). The tag array entries 202(0)-202(N) each also includes a tag 208(0)-208(N), which serves as an identifier for the corresponding instruction block header cache entry 136(0)-136(N). In some aspects, the tags 208(0)-208(N) may comprise a virtual address of the instruction block 104(0)-104(X) for which instruction block header data is being cached. Some aspects may further provide that the tags 208(0)-208(N) comprise only a subset of the bits (e.g., only the lower order bits) of the virtual address of the instruction block 104(0)-104(X).

Similar to the tag array entries 202(0)-202(N), each of the instruction block header cache entries 136(0)-136(N) provides a valid indicator (“VALID”) 210(0)-210(N) representing a current validity of the instruction block header cache entry 136(0)-136(N). The instruction block header cache entries 136(0)-136(N) also store instruction block header data 212(0)-212(N). As noted above, the instruction block header data 212(0)-212(N) may comprise the MBH 132 generated by the MBH generation circuit 130 for the corresponding instruction block 104(0)-104(X), or may comprise the ABH 110(0)-110(X) of the instruction block 104(0)-104(X).

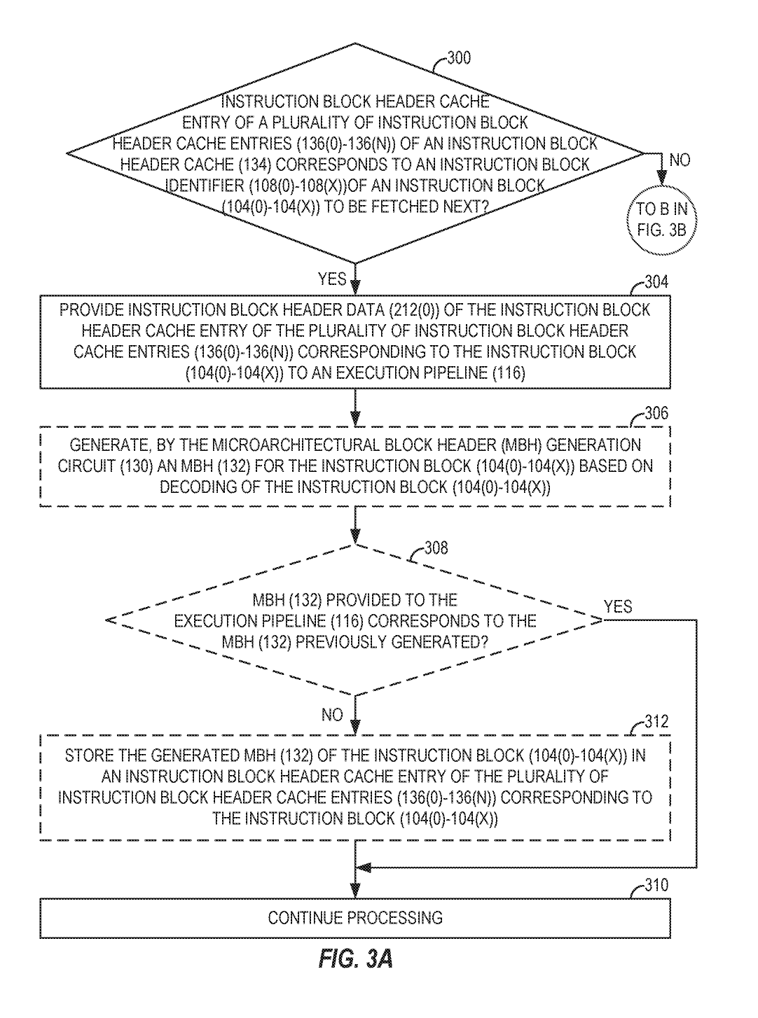

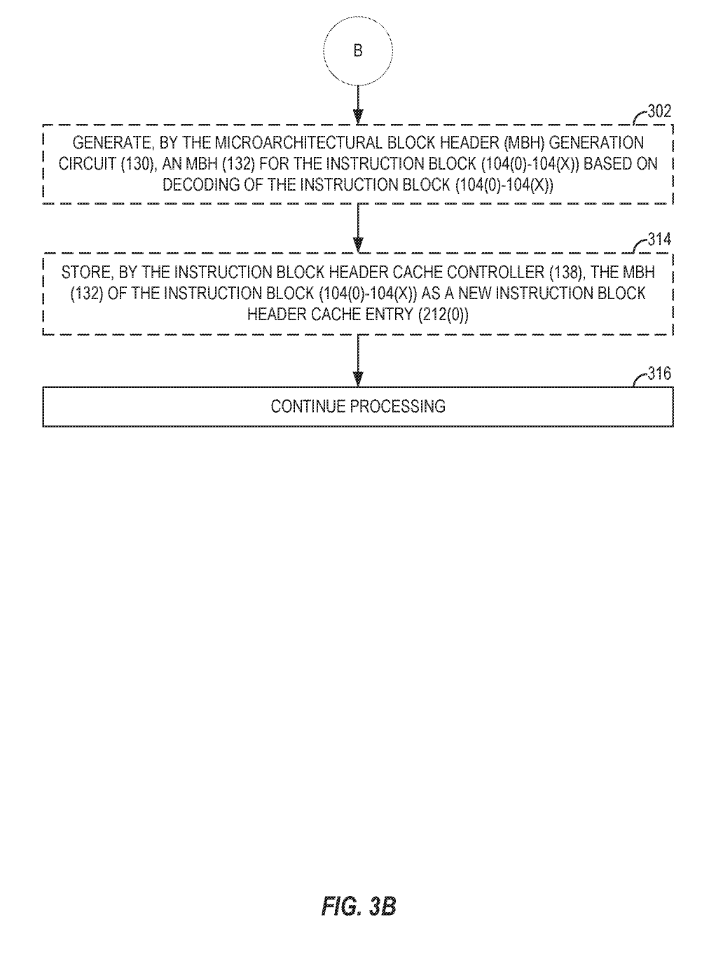

To illustrate exemplary operations of the instruction block header cache 134 and the instruction block header cache controller 138 of FIG. 1 for caching instruction block header data, FIGS. 3A and 3B are provided. In the example of FIGS. 3A and 3B, it is assumed that the instruction block header data comprises the MBH 132 generated by the MBH generation circuit 130 of FIG. 1. Elements of FIGS. 1 and 2 are referenced in describing FIGS. 3A and 3B, for the sake of clarity. Operations in FIG. 3A begin with the instruction block header cache controller 138 determining whether an instruction block header cache entry of the plurality of instruction block header cache entries 136(0)-136(N) of the instruction block header cache 134 corresponds to an instruction block identifier 108(0)-108(X) of an instruction block 104(0)-104(X) to be fetched next (block 300). In this regard, the instruction block header cache controller 138 may be referred to herein as “a means for determining whether an instruction block header cache entry of a plurality of instruction block header cache entries of an instruction block header cache corresponds to an instruction block identifier of an instruction block to be fetched next.”

If no corresponding instruction block header cache entry 136(0)-136(N) exists (i.e., a cache miss occurs), processing resumes at block 302 of FIG. 3B. However, if the instruction block header cache controller 138 determines at decision block 300 that an instruction block header cache entry 136(0)-136(N) corresponds to the instruction block identifier 108(0)-108(X) (i.e., a cache hit), the instruction block header cache controller 138 provides the instruction block header data 212(0)-212(N) (in this example, a cached MBH 132) of the instruction block header cache entry of the plurality of instruction block header cache entries 136(0)-136(N) corresponding to the instruction block 104(0)-104(X) to the execution pipeline 116 (block 304). Accordingly, the instruction block header cache controller 138 may be referred to herein as “a means for providing instruction block header data of the instruction block header cache entry of the plurality of instruction block header cache entries corresponding to the instruction block to an execution pipeline, responsive to determining that an instruction block header cache entry of the plurality of instruction block header cache entries of the instruction block header cache corresponds to the instruction block identifier.”

In some aspects, the MBH generation circuit 130 subsequently generates an MBH 132 for the instruction block 104(0)-104(X) based on decoding of the instruction block 104(0)-104(X) (block 306). The MBH generation circuit 130 thus may be referred to herein as “a means for generating an MBH for the instruction block based on decoding of the instruction block.” The instruction block header cache controller 138 then determines whether the MBH 132 provided to the execution pipeline 116 corresponds to the MBH 132 previously generated (block 308). In this regard, the instruction block header cache controller 138 may be referred to herein as “a means for determining, prior to the instruction block being committed, whether the MBH provided to the execution pipeline corresponds to the MBH previously generated, further responsive to determining that an instruction block header cache entry of the plurality of instruction block header cache entries of the instruction block header cache corresponds to the instruction block identifier.”

If the instruction block header cache controller 138 determines at decision block 308 that the MBH 132 provided to the execution pipeline 116 corresponds to the MBH 132 previously generated, processing continues (block 310). However, if the MBH 132 previously generated does not correspond to the MBH 132 provided to the execution pipeline 116, the instruction block header cache controller 138 stores the MBH 132 previously generated of the instruction block 104(0) in an instruction block header cache entry of the plurality of instruction block header cache entries 136(0)-136(N) corresponding to the instruction block 104(0)-104(X) (block 312). Accordingly, the instruction block header cache controller 138 may be referred to herein as “a means for storing the MBH previously generated of the instruction block in an instruction block header cache entry of the plurality of instruction block header cache entries corresponding to the instruction block, responsive to determining that the MBH provided to the execution pipeline does not correspond to the MBH previously generated.” Processing then continues at block 310.

Referring now to FIG. 3B, if a cache miss occurs at decision block 300 of FIG. 3A, the MBH generation circuit 130 generates an MBH 132 for the instruction block 104(0)-104(X) based on decoding of the instruction block 104(0)-104(X) (block 302). The MBH generation circuit 130 thus may be referred to herein as “a means for generating an MBH for the instruction block based on decoding of the instruction block.” The instruction block header cache controller 138 then stores the MBH 132 of the instruction block 104(0)-104(X) as a new instruction block header cache entry 136(0)-136(N) (block 314). In this regard, the instruction block header cache controller 138 may be referred to herein as “a means for storing the MBH of the instruction block as a new instruction block header cache entry, responsive to determining that an instruction block header cache entry of the plurality of instruction block header cache entries of the instruction block header cache does not correspond to the instruction block identifier.” Processing then continues at block 316.

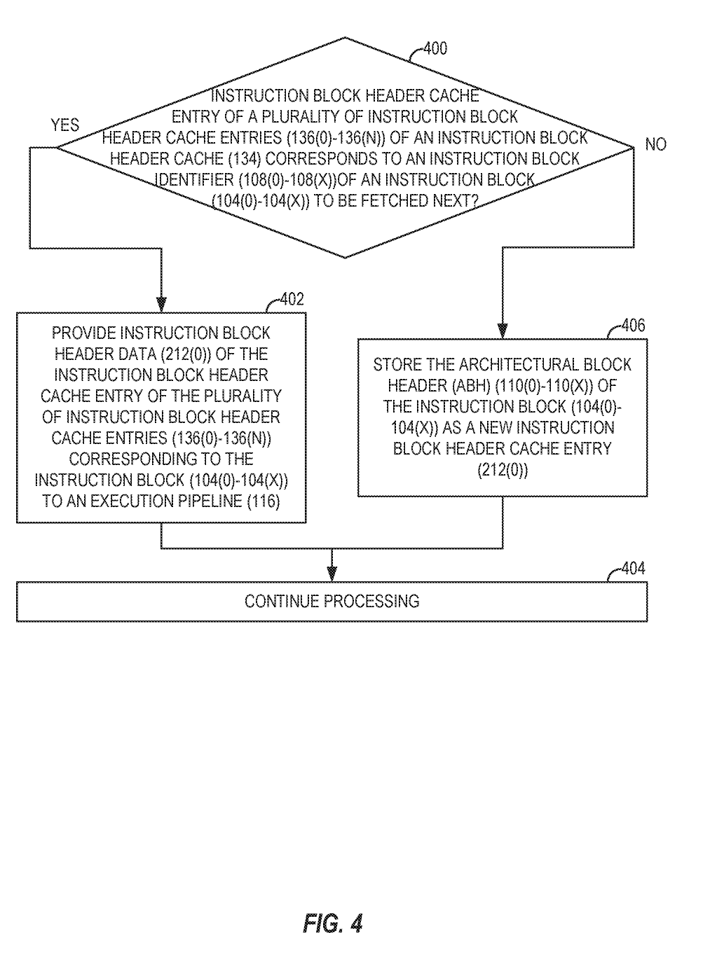

FIG. 4 is a flowchart illustrating additional exemplary operations of the instruction block header cache 134 and the instruction block header cache controller 138 of FIG. 1 for caching instruction block header data comprising an ABH, such as one of the ABHs 110(0)-110(X). For the sake of clarity, elements of FIGS. 1 and 2 are referenced in describing FIG. 4. In FIG. 4, operations begin with the instruction block header cache controller 138 determining whether an instruction block header cache entry of a plurality of instruction block header cache entries 136(0)-136(N) of the instruction block header cache 134 corresponds to an instruction block identifier 108(0)-108(X) of an instruction block 104(0)-104(X) to be fetched next (block 400). Accordingly, the instruction block header cache controller 138 may be referred to herein as “a means for determining whether an instruction block header cache entry of a plurality of instruction block header cache entries of an instruction block header cache corresponds to an instruction block identifier of an instruction block to be fetched next.”

If the instruction block header cache controller 138 determines at decision block 400 that an instruction block header cache entry 136(0)-136(N) corresponds to the instruction block identifier 108(0)-108(X) (i.e., a cache hit), the instruction block header cache controller 138 provides the instruction block header data 212(0)-212(N) (in this example, a cached ABH 110(0)-110(X)) of the instruction block header cache entry of the plurality of instruction block header cache entries 136(0)-136(N) corresponding to the instruction block 104(0)-104(X) to the execution pipeline 116 (block 402). The instruction block header cache controller 138 thus may be referred to herein as “a means for providing instruction block header data of the instruction block header cache entry of the plurality of instruction block header cache entries corresponding to the instruction block to an execution pipeline, responsive to determining that an instruction block header cache entry of the plurality of instruction block header cache entries of the instruction block header cache corresponds to the instruction block identifier.” Processing then continues at block 404.

However, if it is determined at decision block 400 that no corresponding instruction block header cache entry 136(0)-136(N) exists (i.e., a cache miss occurs), the instruction block header cache controller 138 stores the ABH 110(0)-110(X) of the instruction block 104(0)-104(X) as a new instruction block header cache entry 136(0)-136(N) (block 406). In this regard, the instruction block header cache controller 138 may be referred to herein as “a means for storing the ABH of the instruction block as a new instruction block header cache entry, responsive to determining that an instruction block header cache entry of the plurality of instruction block header cache entries of the instruction block header cache does not correspond to the instruction block identifier.” Processing then continues at block 404.

Caching instruction block header data in block architecture processor-based systems according to aspects disclosed herein may be provided in or integrated into any processor-based system. Examples, without limitation, include a set top box, an entertainment unit, a navigation device, a communications device, a fixed location data unit, a mobile location data unit, a global positioning system (GPS) device, a mobile phone, a cellular phone, a smart phone, a session initiation protocol (SIP) phone, a tablet, a phablet, a server, a computer, a portable computer, a mobile computing device, a wearable computing device (e.g., a smart watch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

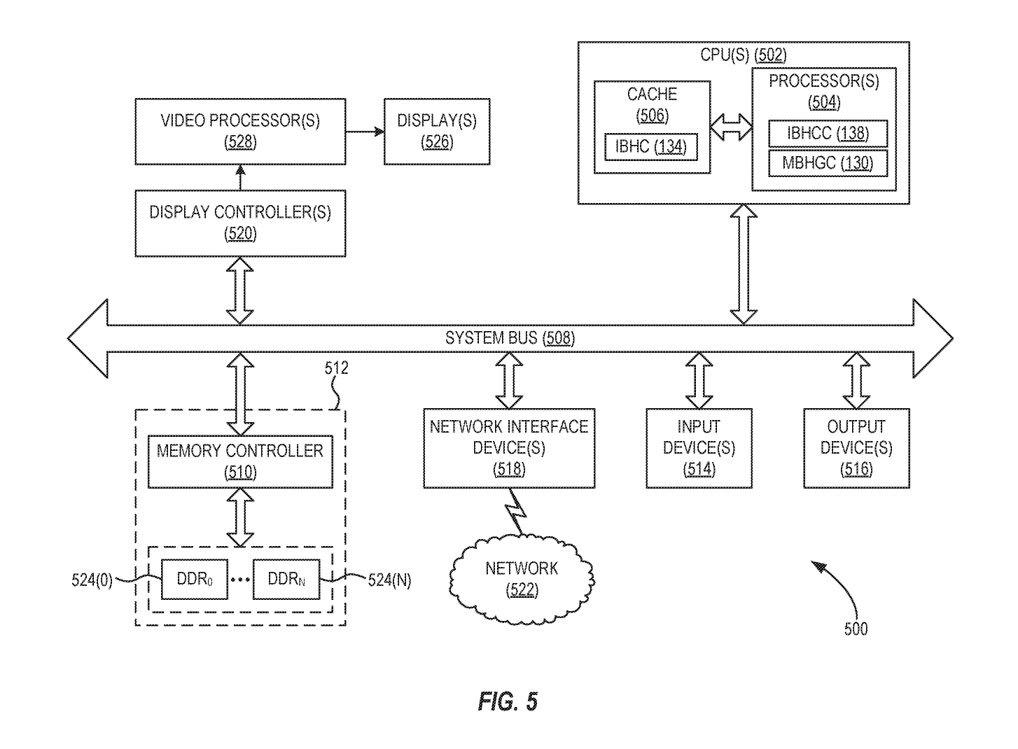

In this regard, FIG. 5 illustrates an example of a processor-based system 500 that corresponds to the block architecture processor-based system 100 of FIG. 1. The processor-based system 500 includes one or more CPUs 502, each including one or more processors 504. The processor(s) 504 may comprise the instruction block header cache controller (“IBHCC”) 138 and the MBH generation circuit (“MBHGC”) 130 of FIG. 1. The CPU(s) 502 may have cache memory 506 that is coupled to the processor(s) 504 for rapid access to temporarily stored data. The cache memory 506 may comprise the instruction block header cache (“IBHC”) 134 of FIG. 1. The CPU(s) 502 is coupled to a system bus 508 and can intercouple master and slave devices included in the processor-based system 500. As is well known, the CPU(s) 502 communicates with these other devices by exchanging address, control, and data information over the system bus 508. For example, the CPU(s) 502 can communicate bus transaction requests to a memory controller 510 as an example of a slave device.

Other master and slave devices can be connected to the system bus 508. As illustrated in FIG. 5, these devices can include a memory system 512, one or more input devices 514, one or more output devices 516, one or more network interface devices 518, and one or more display controllers 520, as examples. The input device(s) 514 can include any type of input device, including, but not limited to, input keys, switches, voice processors, etc. The output device(s) 516 can include any type of output device, including, but not limited to, audio, video, other visual indicators, etc. The network interface device(s) 518 can be any devices configured to allow exchange of data to and from a network 522. The network 522 can be any type of network, including, but not limited to, a wired or wireless network, a private or public network, a local area network (LAN), a wireless local area network (WLAN), a wide area network (WAN), a BLUETOOTH™ network, and the Internet. The network interface device(s) 518 can be configured to support any type of communications protocol desired. The memory system 512 can include one or more memory units 524(0)-524(N).

The CPU(s) 502 may also be configured to access the display controller(s) 520 over the system bus 508 to control information sent to one or more displays 526. The display controller(s) 520 sends information to the display(s) 526 to be displayed via one or more video processors 528, which process the information to be displayed into a format suitable for the display(s) 526. The display(s) 526 can include any type of display, including, but not limited to, a cathode ray tube (CRT), a liquid crystal display (LCD), a plasma display, etc.

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. A block-based computer processor device of a block architecture processor-based system, comprising:
an instruction block header cache comprising a plurality of instruction block header cache entries each configured to store instruction block header data corresponding to an instruction block; and
an instruction block header cache controller configured to:
determine whether an instruction block header cache entry of the plurality of instruction block header cache entries of the instruction block header cache corresponds to an instruction block identifier of an instruction block to be fetched next; and
responsive to determining that an instruction block header cache entry of the plurality of instruction block header cache entries of the instruction block header cache corresponds to the instruction block identifier, provide the instruction block header data of the instruction block header cache entry to an execution pipeline.

2. The block-based computer processor device of claim 1, wherein:
the plurality of instruction block header cache entries are each configured to store a microarchitectural block header (MBH) as the instruction block header data;
the block-based computer processor device further comprises an MBH generation circuit configured to generate an MBH for the instruction block based on decoding of the instruction block; and
the instruction block header cache controller is further configured to, responsive to determining that an instruction block header cache entry of the plurality of instruction block header cache entries of the instruction block header cache does not correspond to the instruction block identifier, store the MBH of the instruction block as a new instruction block header cache entry.

3. The block-based computer processor device of claim 2, wherein the MBH comprises one or more of data relating to register reads and writes within the instruction block, data relating to load and store operations within the instruction block, data relating to branches within the instruction block, data related to predicate information within the instruction block, data related to special instructions within the instruction block, and data related to serial execution preferences for the instruction block.

4. The block-based computer processor device of claim 2, wherein the instruction block header cache controller is further configured to, further responsive to determining that an instruction block header cache entry of the plurality of instruction block header cache entries of the instruction block header cache corresponds to the instruction block identifier:
prior to the instruction block being committed, determine whether the MBH provided to the execution pipeline corresponds to the MBH previously generated; and
responsive to determining that the MBH provided to the execution pipeline does not correspond to the MBH previously generated, store the MBH previously generated of the instruction block in an instruction block header cache entry of the plurality of instruction block header cache entries corresponding to the instruction block.

5. The block-based computer processor device of claim 1, wherein:
the plurality of instruction block header cache entries are each configured to store an architectural block header (ABH) as the instruction block header data; and
the instruction block header cache controller is further configured to, responsive to determining that an instruction block header cache entry of the plurality of instruction block header cache entries of the instruction block header cache does not correspond to the instruction block identifier, store the ABH of the instruction block as a new instruction block header cache entry.

6. The block-based computer processor device of claim 1, wherein the plurality of instruction block header cache entries are each further configured to store an instruction block virtual address for indexing and tagging.

7. The block-based computer processor device of claim 1, wherein the plurality of instruction block header cache entries are each further configured to store a subset of bits of an instruction block virtual address for indexing and tagging.

8. The block-based computer processor device of claim 1 integrated into an integrated circuit (IC).

9. The block-based computer processor device of claim 1 integrated into a device selected from the group consisting of: a set top box; an entertainment unit; a navigation device; a communications device; a fixed location data unit; a mobile location data unit; a global positioning system (GPS) device; a mobile phone; a cellular phone; a smart phone; a session initiation protocol (SIP) phone; a tablet; a phablet; a server; a computer; a portable computer; a mobile computing device; a wearable computing device; a desktop computer; a personal digital assistant (PDA); a monitor; a computer monitor; a television; a tuner; a radio; a satellite radio; a music player; a digital music player; a portable music player; a digital video player; a video player; a digital video disc (DVD) player; a portable digital video player; an automobile; a vehicle component; avionics systems; a drone; and a multicopter.

10. A method for caching instruction block header data of instruction blocks in a block-based computer processor device, comprising:
determining, by an instruction block header cache controller, whether an instruction block header cache entry of a plurality of instruction block header cache entries of an instruction block header cache corresponds to an instruction block identifier of an instruction block to be fetched next; and
responsive to determining that an instruction block header cache entry of the plurality of instruction block header cache entries of the instruction block header cache corresponds to the instruction block identifier, providing instruction block header data of the instruction block header cache entry of the plurality of instruction block header cache entries corresponding to the instruction block to an execution pipeline.

11. The method of claim 10, wherein:
the plurality of instruction block header cache entries are each configured to store a microarchitectural block header (MBH) as the instruction block header data; and
the method further comprises:
generating, by an MBH generation circuit, an MBH for the instruction block based on decoding of the instruction block; and
responsive to determining that an instruction block header cache entry of the plurality of instruction block header cache entries of the instruction block header cache does not correspond to the instruction block identifier, storing, by the instruction block header cache controller, the MBH of the instruction block as a new instruction block header cache entry.

12. The method of claim 11, wherein the MBH comprises one or more of data relating to register reads and writes within the instruction block, data relating to load and store operations within the instruction block, data relating to branches within the instruction block, data related to predicate information within the instruction block, data related to special instructions within the instruction block, and data related to serial execution preferences for the instruction block.

13. The method of claim 11, comprising, further responsive to determining that an instruction block header cache entry of the plurality of instruction block header cache entries of the instruction block header cache corresponds to the instruction block identifier:
prior to the instruction block being committed, determining whether the MBH provided to the execution pipeline corresponds to the MBH previously generated; and
responsive to determining that the MBH provided to the execution pipeline does not correspond to the MBH previously generated, storing the MBH previously generated of the instruction block in an instruction block header cache entry of the plurality of instruction block header cache entries corresponding to the instruction block.

14. The method of claim 10, wherein:
the plurality of instruction block header cache entries are each configured to store an architectural block header (ABH) as the instruction block header data; and
the method further comprises, responsive to determining that an instruction block header cache entry of the plurality of instruction block header cache entries of the instruction block header cache does not correspond to the instruction block identifier, storing the ABH of the instruction block as a new instruction block header cache entry.

15. The method of claim 10, wherein the plurality of instruction block header cache entries are each further configured to store an instruction block virtual address for indexing and tagging.

16. The method of claim 10, wherein the plurality of instruction block header cache entries are each further configured to store a subset of bits of an instruction block virtual address for indexing and tagging.

17. A block-based computer processor device of a block architecture processor-based system, comprising:
a means for determining whether an instruction block header cache entry of a plurality of instruction block header cache entries of an instruction block header cache corresponds to an instruction block identifier of an instruction block to be fetched next; and
a means for providing instruction block header data of the instruction block header cache entry of the plurality of instruction block header cache entries corresponding to the instruction block to an execution pipeline, responsive to determining that an instruction block header cache entry of the plurality of instruction block header cache entries of the instruction block header cache corresponds to the instruction block identifier.

18. The block-based computer processor device of claim 17, wherein:
the plurality of instruction block header cache entries are each configured to store a microarchitectural block header (MBH) as the instruction block header data; and
the block-based computer processor device further comprises:
a means for generating an MBH for the instruction block based on decoding of the instruction block; and
a means for storing the MBH of the instruction block as a new instruction block header cache entry, responsive to determining that an instruction block header cache entry of the plurality of instruction block header cache entries of the instruction block header cache does not correspond to the instruction block identifier.

19. The block-based computer processor device of claim 18, further comprising:
a means for determining, prior to the instruction block being committed, whether the MBH provided to the execution pipeline corresponds to the MBH previously generated, further responsive to determining that an instruction block header cache entry of the plurality of instruction block header cache entries of the instruction block header cache corresponds to the instruction block identifier; and
a means for storing the MBH previously generated of the instruction block in an instruction block header cache entry of the plurality of instruction block header cache entries corresponding to the instruction block, responsive to determining that the MBH provided to the execution pipeline does not correspond to the MBH previously generated.

20. The block-based computer processor device of claim 17, wherein:
the plurality of instruction block header cache entries are each configured to store an architectural block header (ABH) as the instruction block header data; and
the block-based computer processor device further comprises a means for storing the ABH of the instruction block as a new instruction block header cache entry, responsive to determining that an instruction block header cache entry of the plurality of instruction block header cache entries of the instruction block header cache does not correspond to the instruction block identifier.

21. A non-transitory computer-readable medium having stored thereon computer-executable instructions which, when executed by a processor, cause the processor to:
determine whether an instruction block header cache entry of a plurality of instruction block header cache entries of an instruction block header cache corresponds to an instruction block identifier of an instruction block to be fetched next; and
responsive to determining that an instruction block header cache entry of the plurality of instruction block header cache entries of the instruction block header cache corresponds to the instruction block identifier, provide instruction block header data of the instruction block header cache entry of the plurality of instruction block header cache entries corresponding to the instruction block to an execution pipeline.

22. The non-transitory computer-readable medium of claim 21 having stored thereon computer-executable instructions which, when executed by a processor, further cause the processor to:
generate a microarchitectural block header (MBH) for the instruction block based on decoding of the instruction block; and
responsive to determining that an instruction block header cache entry of the plurality of instruction block header cache entries of the instruction block header cache does not correspond to the instruction block identifier, store, by an instruction block header cache controller, the MBH of the instruction block as the instruction block header data of a new instruction block header cache entry.

23. The non-transitory computer-readable medium of claim 22, wherein the MBH comprises one or more of data relating to register reads and writes within the instruction block, data relating to load and store operations within the instruction block, data relating to branches within the instruction block, data relating to predicate information within the instruction block, data relating to special instructions within the instruction block, and data relating to serial execution preferences for the instruction block.

24. The non-transitory computer-readable medium of claim 22 having stored thereon computer-executable instructions which, when executed by a processor, further cause the processor to, further responsive to determining that an instruction block header cache entry of the plurality of instruction block header cache entries of the instruction block header cache corresponds to the instruction block identifier:
prior to the instruction block being committed, determine whether the MBH provided to the execution pipeline corresponds to the MBH previously generated; and
responsive to determining that the MBH provided to the execution pipeline does not correspond to the MBH previously generated, store the MBH previously generated of the instruction block in an instruction block header cache entry of the plurality of instruction block header cache entries corresponding to the instruction block.

25. The non-transitory computer-readable medium of claim 21 having stored thereon computer-executable instructions which, when executed by a processor, further cause the processor to, responsive to determining that an instruction block header cache entry of the plurality of instruction block header cache entries of the instruction block header cache does not correspond to the instruction block identifier, storing an architectural block header (ABH) of the instruction block as the instruction block header data for a new instruction block header cache entry.

26. The non-transitory computer-readable medium of claim 21, wherein the plurality of instruction block header cache entries are each further configured to store an instruction block virtual address for indexing and tagging.

27. The non-transitory computer-readable medium of claim 21, wherein the plurality of instruction block header cache entries are each further configured to store a subset of bits of an instruction block virtual address for indexing and tagging.
